(19) United States
(12) Patent Application Publication
(10) Pub. No.: US 2012/0330925 A1
(43) Pub. Date: Dec. 27, 2012

(54) OPTIMIZING FINE GRAINED ACCESS CONTROL USING AUTHORIZATION INDEXES

(75) Inventors: Ravi Ramamurthy, Redmond, WA (US); Raghav Kaushik, Bellevue, WA (US); Abhijeet Mohapatra, Palo Alto, CA (US)

(73) Assignee: Microsoft Corporation, Redmond, WA (US)

(21) Appl. No.: 13/166,828

(22) Filed: Jun. 23, 2011

(51) Int. Cl. G06F 17/30

(52) U.S. Cl. 707/718; 707/783; 707/719; 707/713; 707/E17.005; 707/E17.017

(57) ABSTRACT

Architecture that is an index mechanism which optimizes complex queries that result from enforcing fine grained access control. The architecture addresses the problem of efficient query evaluation in the presence of fine grained access control. The index mechanism is a structure (referred to as authorization indexes) which provides expedient access to the authorized tuples of a particular user in a table. The index is maintained by utilizing view maintenance algorithms. The index can be built for only certain groups/roles (referred to as partial authorization indexes). Additionally, the authorization index can be used to create a cost-based query rewriter, as well as authorization-aware query optimizer.

### BACKGROUND

Fine grained access control is a natural requirement for many applications, and some commercial systems have recently started added support for specifying such policies. Applications can leverage this functionality by specifying a policy (using the notion of predicated grants) and the database system will enforce this policy by suitably rewriting queries. The authorization policies can use complex SQL (structured query language) constructs such as subqueries and union, thus increasing the complexity and cost of the rewritten queries.

Fine grained access control in database queries is typically implemented by rewriting input queries suitably to enforce the access control policies. However, such rewriting can also increase the complexity of the original queries (especially for authorization policies that contain complex constructs such as subqueries).

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture is an index mechanism that is used to optimize complex queries that result from enforcing fine grained access control. The architecture addresses the problem of efficient query evaluation in the presence of fine grained access control. The index mechanism is a structure (referred to as authorization indexes) which provides expedient access to the authorized tuples of a particular user in a table. The index is maintained by utilizing view maintenance algorithms. The index can be built for only certain groups/roles (referred to as partial authorization indexes). Additionally, the authorization index can be used to create a cost-based query rewriter, as well as authorization-aware query optimizer.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates an original query and the query plans obtained by adding the authorization predicates and by using the authorization indexes.

FIG. 3 illustrates alternative query plans for one table and adds the authorization predicates for another table.

FIG. 4 illustrates an exemplary database management system that employs a cost-based query rewriter.

FIG. 5 illustrates a greedy algorithm for query rewriting.

FIG. 6 illustrates a local greedy algorithm, which is a variant on the greedy algorithm of FIG. 5.

FIG. 7 illustrates an exemplary database management system that employs an authorization-aware query optimizer.

FIG. 8 illustrates a snapshot of a plan memo for a join query.

FIG. 9 illustrates a snapshot of a memo for an authorization-aware optimizer.

FIG. 10 illustrates a computer-implemented method in accordance with the disclosed architecture.

FIG. 11 illustrates further aspects of the method of FIG. 10.

FIG. 12 illustrates a block diagram of a computing system that executes fine grained access control in accordance with the disclosed architecture.

### DETAILED DESCRIPTION

The disclosed architecture is a new auxiliary structure referred to as an authorization index to a database system. An authorization index is a database object with the following properties. An authorization index is a DDL (data definition language) construct. An authorization index is created via a create authorization index statement that specifies a table. The authorization index stores the mapping between users and the corresponding record identifiers (RIDs) that the users are allowed to access. The authorization index is an auxiliary structure (it is not necessary to create an authorization index in order to enforce authorizations). The index is similar to indexes and different from materialized views in that applications are not permitted to reference the authorization index by name.

An authorization index is authorization-aware, which differentiates the authorization index from traditional indexes and materialized views. In order to create the index, in addition to the table which is being indexed, an authorization policy (that is stored as part of the system catalog) and a view that specifies the set of userIDs, are utilized. By binding the index to the authorization policy, the query processing subsystem utilizes an authorization index without any need for complex view matching. An “index-seek” operation performed over the authorization index to retrieve the authorized tuples of a particular user is equivalent to applying the authorization predicate independent of its complexity.

An authorization index is used in a cost-based manner by the query rewriter/query optimizer. A first implementation augments the query rewriter to be aware of the presence of authorization indexes. For each table, the query rewriter chooses to rewrite the query using either the authorization predicate or an authorization index. The query is rewritten in a way that minimizes the overall cost. A second implementation is an authorization-aware query optimizer that combines the query rewriting and the selection of the appropriate authorization indexes in a single optimization call.

In order to maintain an authorization index as the data changes, incremental maintenance of views is utilized. This implies that authorization indexes can only be constructed for a limited class of authorizations. However, this is a much larger class than is supported in existing commercial systems as materialized views. A larger class is possible since the view matching cost is not incurred.

In general, the authorization index is built only for a subset of the users for the table. For example, certain users who are authorized to see a large fraction of the tuples can be excluded (e.g., the President of a company). This improves the storage efficiency and maintenance costs of the index.

Following is background with respect to query processing in a rewrite-then-optimize architecture.

With access control, each database user obtains access to a view of the database that the user can query. The set of views published constitutes an access control policy P. Existing implementations (e.g., SQL) enable coarse grained access to entire tables and views. Under existing models of fine grained access control emphasize supporting predicate based fine-grained access control policies in the database server. An application can specify a policy for each database table using the notion of predicated grants. The database system enforces this policy for all queries that access the table by appropriately rewriting the queries.

The conventional components for enforcing fine grained access control, the notion of predicated grants and the query rewriter module in the database system are now reviewed.

It is assumed that an application specifies an access control policy P for each table in the database, the model used by commercial systems. The policy uses the notion of a predicated grant, which specifies the subset of rows in the table that is authorized for each user. This is expressed by specifying a predicate that is parameterized by a user identifier (userID) value that uniquely identifies each user of the table. For example, consider a policy for the TPC-H (TPC Benchmark™ H—a decision support benchmark) database in which each customer is only allowed to see their own orders. It is assumed herein that the function userID( ) provides the identity of the current application user. The policy can be specified as follows.

```
  grant
  select on orders
  where (o_custkey = userID( ))
to public
```

The predicates that can be used to restrict access to a subset of the tuples in the table can, in general, involve complicated SQL constructs such as subqueries and union.

With respect to the query rewriter, while predicated grants are used to specify fine grained authorizations, the database system enforces the specified policy by using the notion of query rewriting. The input queries are rewritten by adding appropriate predicates for each table.

In a traditional rewrite-then-optimize architecture, query rewriting in a database system, the original query Q is rewritten by a query rewriter (using the input policy based on predicated grants) to the query Q′. The query Q′ is, in turn, optimized by a query optimizer and the corresponding query execution plan obtained is executed by the execution engine.

This rewrite-then-optimize architecture separates the authorization subsystem from the query processing subsystem. The query rewriter takes an input query (e.g., SQL) and generates a rewritten query (e.g., SQL). Note that the query rewriter module is not cost-based and enforces the authorizations through the rewrite. The query optimizer takes as input the rewritten query and is not aware of the authorizations, and thus, need not be extended in any way to obtain a correct query execution plan that is consistent with the input policy. The following examples illustrate how query rewriting works.

Consider the example grant illustrated above which restricts each customer to see their own orders in the TPC-H database. The following query:

select * from orders
where o_orderdate > ’2008-01-01’

gets rewritten to:

select * from orders
where o_orderdate > ’2008-01-01’
and o_custkey = userID( )

Consider a policy on the TPC-H database that restricts a customer to see only the parts that correspond to some lineitems that were ordered by the customer. The following query:

select * from parts

gets rewritten to:

```
select * from part
  where exists
      (
        select * from lineitem
        where l_partkey = p_partkey
        and exists
            (
              select * from orders
              where l_orderkey = o_orderkey
              and o_custkey = userID( )
            )
      )
```

A benefit of using query rewriting is that existing applications need not be modified in order to incorporate fine grained authorizations. Once the appropriate predicated grants are specified, the applications can be run without any changes since query rewriting is completely transparent to the application.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

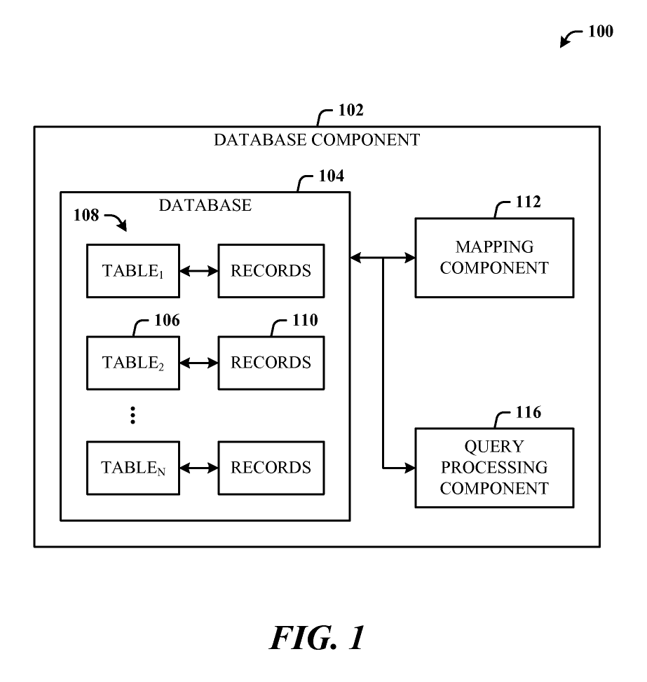

FIG. 1 illustrates a system 100 in accordance with the disclosed architecture. The system 100 includes a database component 102 that includes a database 104 having a table 106 (of multiple tables 108) and associated table records 110 against which a query is processed. The system 100 can also comprise a mapping component 112 (also referred to as an authorization index) that maintains a mapping of a user identifier of a user to corresponding records the user is allowed to access in the table 106. The mapping is maintained in an appropriate (suitable) format for processing by a rewrite-then-optimize architecture.

The system 100 can also include a query processing component 116 that employs the mapping in association with a query rewriter. The query rewriter is a cost-aware rewriter that rewrites the query based on consideration of either an authorization predicate or the mapping. The query processing component 116 can alternatively employ the mapping in association with a query optimizer. The query optimizer is an authorization-aware query optimizer that combines rewriting of the query and selection of a suitable mapping, in a single optimization call.

The mapping is created based on an authorization policy, a corresponding table, and a view that specifies a set of user identifiers. The mapping can be a partial mapping that is created specific to a role or user-defined group. The mapping is maintained according to at least one of base relations on which authorizations are defined, users that have access to the table 106, or an authorization policy to the table 106. The mapping is incrementally updated based on an incremental maintenance of views using delta propagation rules.

Following is a detailed description of the disclosed fine grained access control in accordance with the disclosed architecture that employs authorization indexes.

The new DDL structure, termed an authorization index, provides a “fast-path” for accessing data that is authorized for a particular user or group. The disclosed architecture creates and maintains authorization indexes and ways in which the query rewriter and query optimizer can utilize the authorization index.

DEFINITION 1. Consider a table T. Assume that each tuple in the table is uniquely identified by a surrogate (tᵢ). Given an access control policy P on T, the set of userids U and the predicate access(uᵢ, tᵢ) which returns true if user uᵢ is authorized to access tuple tᵢ under policy P, an authorization index I on table T is defined as:

[symbol]

={(uᵢ, tᵢ)|uᵢ ∈ [symbol] and access(uᵢ, tᵢ) is true}

The surrogate (tᵢ) can be the RID of the tuple or the key value corresponding to any clustered index on the table [symbol] . Thus, authorization indexes maintain the mapping between users and the corresponding RIDs that the users are authorized to access in a table.

In general, an authorization index can be created for only a subset of the users for the table (referred to as a partial authorization index). For example, consider a CEO (Chief Executive Officer) of a company who is authorized to see all employee data; the authorization index tracks this mapping for each tuple in the employee table. Excluding such a user (the CEO) from the index can help improve storage efficiency and maintenance costs of the index.

Such scenarios are managed by providing a mechanism to create an authorization index for only certain roles/user-defined groups in the database system. Assume each user belongs to a unique role. Thus, the option is provided to create an authorization index for users who belong in the “employee” role, but not the “CEO” role. When a user logs in, the database system checks the role that to which the user belongs and can thus determine if an authorization index can be used. (The disclosed techniques naturally extend for the case for the multiple roles.)

Following is a description authorization index creation for a database table. Recall that an authorization policy on a table is specified using a predicated grant. In general, consider the grant statement on a table T of the following form (where predicate P is parameterized using the userID( ) function).
grant select on T where P

The authorization index is maintained incrementally with updates. This is, in general, not feasible for arbitrary authorization predicates P.

A create authorization index statement first checks if the predicated grant for the table falls in a class of predicates that are incrementally maintainable; and otherwise, fails. A create authorization index statement for a table takes as input: the corresponding predicated grant on the table, and a list of userIDs of users who can access this table. These are supplied in a view (USERS(uid)). In some cases, the set of userIDs directly corresponds to the set of values in a database table column, in which case the USERS table can be a view that points to the appropriate column.

A straightforward way of creating the index is to iterate over all user identifiers (uids) in the USERS table and compute the “capability list” corresponding to predicate P and obtain the corresponding RIDS to create the index entry for each uid. However, this step can further be optimized.

Assume that predicate P includes a reference to a table S that contains the predicate parameterized by the userID( ) function (e.g., S.attr=userID( )). For such a predicated grant, the authorization index I for this user-group can be “bulk loaded” by executing the following query (it is assumed the function RID( ) returns the RID/key column for the input row in table T).

insert into I
select distinct uid, RID(t)
from T t, USERS u
where P′

In the above query, predicate P′ is a modified version of the original predicate P that removes the occurrence of S.attr=userID( ) in predicate P and replaces it with S.attr=u.uid. Note that the above procedure essentially outputs the userIDs in addition to the tuple RIDs. Since S.attr may not be a key attribute of relation S, duplicates are filtered from the join between table T and table S (hence, the distinct clause).

The following example illustrates the above method, using the authorization index (e.g., authIndexPart), which can be created by issuing the following query.

```
insert into authIndexPart
select distinct uid, p_partkey
from part as p, USERS u
and exists
(
    select *
    from lineitem
    where l_partkey = p.p_partkey
    and exists
    (
      select *
      from orders
      where l_orderkey = o_orderkey
      and o_custkey = u.uid
    )
)
```

With respect to index maintenance, as with regular indexes, the authorization index is incrementally maintained with updates. Note that updates can include updates made to the base relations on which authorizations are defined, to the set of users that have access to the table (the USERS table described in the previous section), or to the authorization policy to the table.

If the authorization policy corresponding to a table is changed, the authorization index is dropped (deleted). This is similar to a case where the definition of a materialized view is changed; the materialized view is no longer valid.

For updates made to the base relation, the authorization index is incrementally maintained by using delta propagation rules. Appropriate additional metadata (e.g., certain partial counts) may be added to maintain the indexes. The class of predicated grants that can be maintained is described by the following grammar.

```
P := P and P | P or P
    := <attr> op <attr>
    := <attr> op <val>
    := <attr> op agg(Q)
    := exists(Q)
    := true | false
    := not P
Q := SPJ query
:= SPJ query where P
```

As previously described, any create authorization index statement for a table whose predicated grant does not fall in the above class of predicate is disallowed. The authorization policy conformance to the above grammar can be checked at index create time (e.g., in polynomial time). The above language covers a rich class of authorization predicates for which authorization indexes can be used.

Unlike regular indexes, authorization indexes are maintained when the set of users that have access to the table changes. The expression corresponding to the bulk-load query described above can be incrementally maintained with respect to any addition or deletions in the USERS table by running the corresponding delta-version of the query.

Following is a description of the utilization of authorization indexes by the query rewriter/query optimizer (TPC-H Query 14 is used as a running example).

Consider TPC-H Query 14, which is a join of the lineitem and part tables followed by an aggregate computation. Consider a policy in which a customer is only allowed to see lineitems corresponding to the customer orders and parts corresponding to those lineitems. In this case, the original query Agg(Lineitem [symbol] Part) gets rewritten to the following query (where x denotes the left semi-join operator):

Agg((Lineitem [symbol] Orders) [symbol] (Part [symbol] (Lineitem [symbol] Orders)))

Recall that authorization indexes maintain the mapping between users and the corresponding RIDs that the users are authorized to access for a table. Thus, for the join query, a query plan that uses the authorization indexes on Lineitems and Orders to fetch the authorized tuples need not evaluate the additional semi-joins that are introduced due to the authorization predicates, and can potentially result in a much better plan.

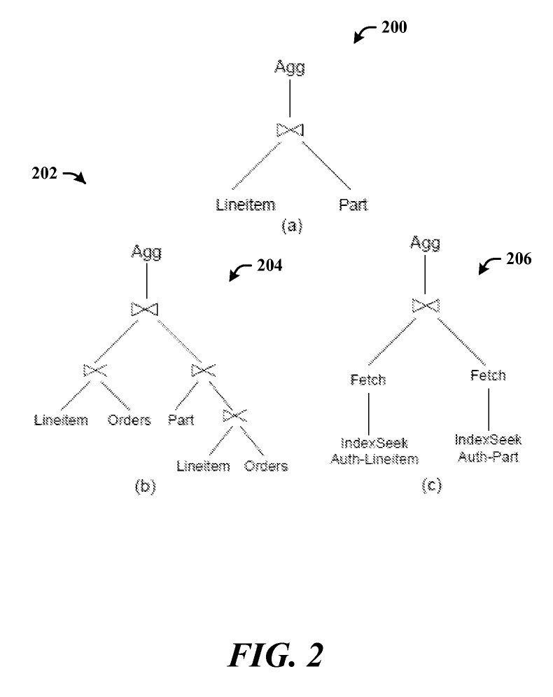

FIG. 2 illustrates an original query 200 and the query plans 202 obtained by adding the authorization predicates and by using the authorization indexes. As shown, authorization indexes provide an alternative means for enforcing the predicated grant on a table rather than adding the authorization predicates.

A way to utilize authorization indexes is to consider using an authorization index for a table, if it were available. However, just like the case of regular indexes, this may not be the best choice as shown in the following example.

Consider the TPC-H Query 14 join described above. Recall that the authorization policy allows a customer to only see lineitems corresponding to the customer's orders and parts corresponding to those lineitems. FIG. 2 shows two query plans: a first query plan 204 that uses the authorization predicates for both tables, and a second query plan 206 that uses the authorization indexes for both tables. Using an authorization index to retrieve all authorized tuples can be efficient if the fraction of tuples in the table that the user is authorized to see is small.

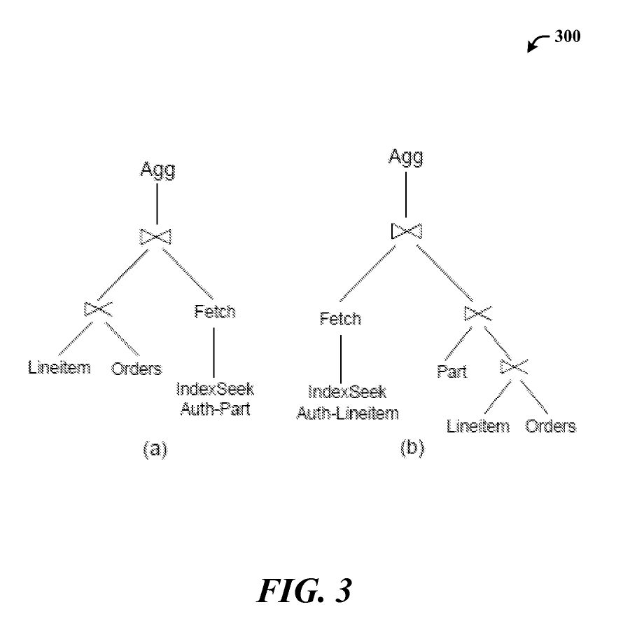

However, in alternative plans 300 that use authorization indexes for one table and adds the authorization predicates for another table, as shown in FIG. 3, may potentially be better choices than the two plans (204 and 206) shown in FIG. 2.

As previously indicated, the choice of authorization should be made in a cost-based manner. Predicated grants can be enforced using a query rewriter that takes an input query and rewrites the query to be consistent with the authorization policy. However, the conventional query rewriter which transforms an input SQL to another SQL query is not cost based, and the query optimizer uses a cost model to choose an execution plan for an input query, but is not aware of the authorization predicates.

Thus, in order to best exploit authorization indexes in a cost-based manner is to either extend the query rewriter to become cost-based or integrate the query rewriter and query optimizer into an authorization-aware query optimizer that combines query rewriting and authorization index selection in a single step.

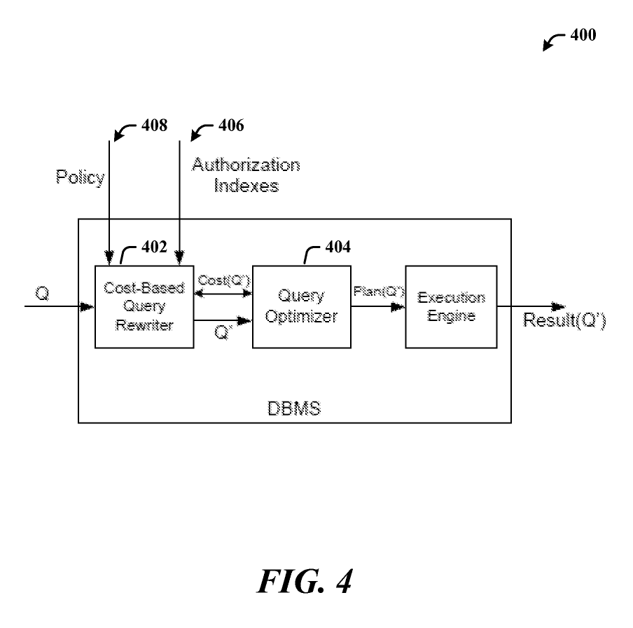

FIG. 4 illustrates an exemplary database management system 400 that employs a cost-based query rewriter 402. The query rewriter 402 is extended to consider a space of query rewritings which have costs computed and assigned (are “costed”) by invoking a query optimizer 404. As shown in FIG. 4, a query Q is input to the query rewriter 402, which rewriter 402 utilizes the query optimizer 404 (employing the Cost(Q) API) to cost different rewritings that use a combination of authorization indexes 406 and authorization predicates 408. In order to ensure that a particular authorization index is used, suitable index hinting mechanisms are used that are supported by all modern query optimizers, as shown in the following example.

Consider the following query on a part table.

select * from part

The query rewriter 402 can force the optimizer 404 to use the authorization index (authPart(UID, RID)) by specifying an index hint, as follows.

select * from part (index: authPart)
where UID = userID( )

This approach can be integrated with the existing rewrite-then-optimize approach and provides a platform to validate the effectiveness of using authorization indexes for query processing. Existing commercial query optimizer supports a tuning mode in which the query optimizer can take additional time in order to compute an improved plan. A cost-based query rewriter can be used in such a tuning mode to obtain improved plans for complex queries by utilizing any existing authorization indexes.

This approach can be suitably employed for ad-hoc queries by using appropriate heuristics such as adding authorization indexes only for certain tables with complex authorizations, using timeouts, etc. The “multiple” optimizer calls can be eliminated by integrating the query rewriter 402 and optimizer 404 in an authorization-aware query optimizer (described below).

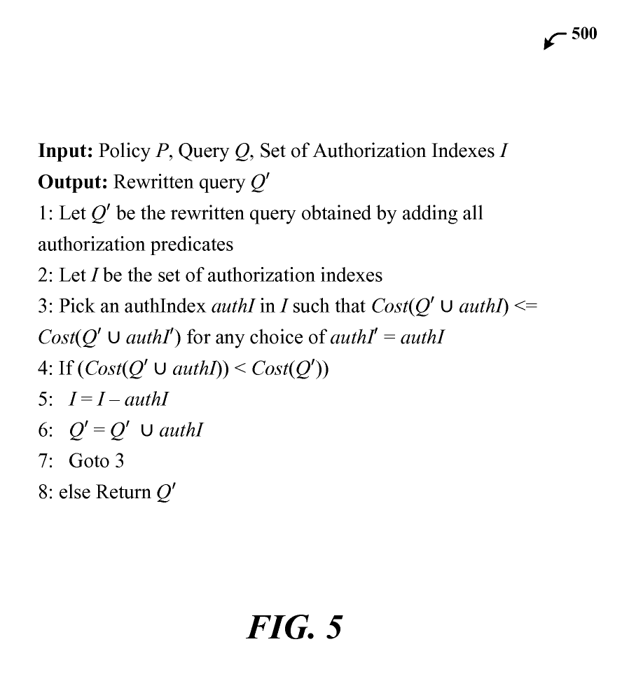

FIG. 5 illustrates a greedy algorithm 500 for query rewriting. The query rewriter 402 takes an input SQL query and obtains the rewritten query by adding the appropriate authorization predicates (also called policies) 408 for each table. In the presence of authorization indexes, the query rewriter 402 has the option (for each table) to choose to add an authorization predicate 408 or forcing the access path for the table to use the authorization index 406. The corresponding query rewriting problem is defined as follows.

DEFINITION 2. Consider a query Q. A rewritten query Q′ is defined to be consistent with an authorization policy P if for each table T in query Q one of the following conditions hold: 1) Q′ includes the corresponding authorization predicates in P for table T or 2) Q′ forces the access path to use any existing authorization index on table T.

DEFINITION 3. The query rewriting problem (in the presence of authorization indexes) takes as input an authorization policy P, a query Q, and a set of authorization indexes I and requires finding the minimal cost query rewriting that is consistent with the policy P.

The choice of an authorization index for one table can influence the choice of authorization indexes for other tables in the query.

Consider a join query (in a TPC-H database) between the Lineitem and Orders tables that are clustered on respective key columns. Assume authorization indexes on both tables that maintain the mapping between userids and the respective key columns of the table. Further assume that the fraction of authorized tuples in both tables are large; thus using the index seek plans on the authorization indexes are expensive. However, a query plan that joins the authorization indexes first before fetching the tuples from both the tables can be the most efficient particularly if the set of “joined” authorized tuples is a small fraction of the respective tables.

The choice of a particular authorization index can depend on the presence of other authorization indexes. In general, finding the optimal rewriting for a query Q requires evaluating 2^{k} different query rewritings, where k is the number of authorization indexes relevant for this query Q.

Since costing each particular rewriting requires an optimization call, this can get expensive for complex queries. The greedy algorithm 500 starts by generating the rewritten query Q′ by adding all authorization predicates for each table that is relevant for this query. In step 3, the algorithm 500 greedily chooses an (additional) authorization index (authI) to add to the query, as long as the query plan thus obtained has lower cost. When an authorization index is added to a query (denoted as Q′ ∪ authI), the corresponding authorization predicate that was originally added for the table is removed. As described previously, the optimizer 404 can be forced to use a particular authorization index by using appropriate query hints.

The algorithm evaluates k² different rewritings in the worst case (in contrast to the 2^{k} rewritings of the exhaustive algorithm). However, due to the constraint that a rewriting is considered only if it improves the cost, the number of rewritings considered is typically much smaller in practice. Under certain assumptions of the cost function, it can be shown that the above greedy algorithm 500 can yield approximation guarantees. In particular, if the cost function is sub-modular, it can be shown that the greedy algorithm 500 is (1−1/e) optimal.

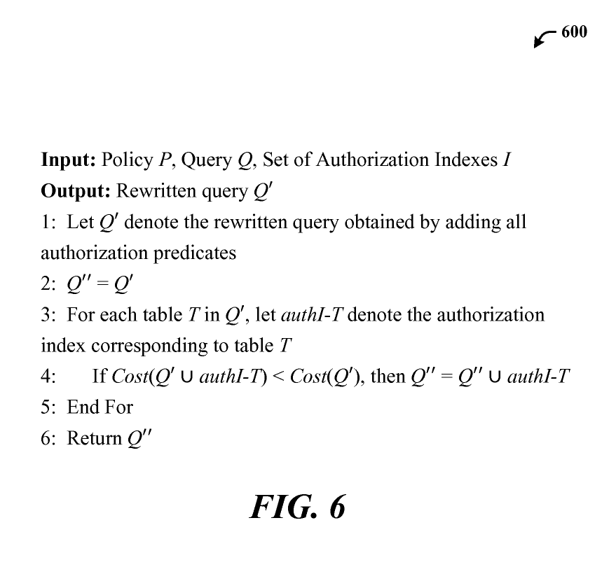

FIG. 6 illustrates a local greedy algorithm 600, which is a variant on the greedy algorithm 500 of FIG. 5. In the local greedy algorithm 600, the decision between the authIndex and the authorization predicates is performed independently for each table in the query (in contrast to greedy algorithm 500).

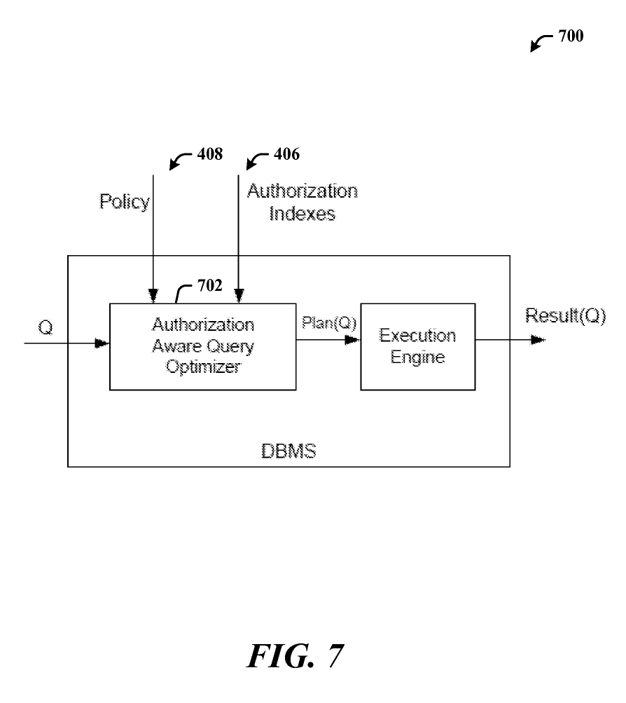

FIG. 7 illustrates an exemplary database management system 700 that employs an authorization-aware query optimizer 702. The system 700 extends a traditional rule-based optimizer to integrate query rewriting and authorization index selection in a single step. The system 700 outlines the architecture for this approach in which the query optimizer takes as input both the authorization policies 408 and the set of authorization indexes 406 and produces the optimum query execution plan.

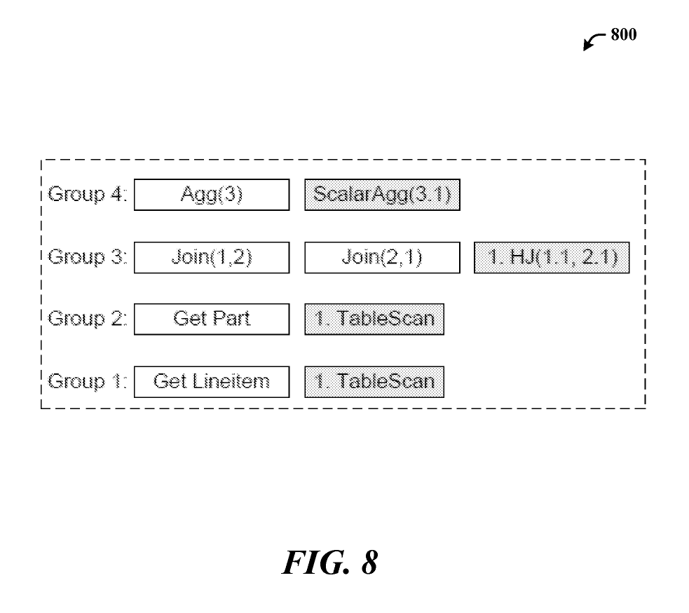

Although a transformation rule-based query optimizer is assumed for this description, the disclosed techniques can be extended for other optimizer architectures as well. A data structure used by transformation rule-based optimizers to keep track of different logical and physical plans is called a memo. FIG. 8 illustrates a snapshot of a plan memo 800 for a join query between the Lineitem and Part.

Each group (e.g., Group 3) represents a set of equivalent logical expressions and keeps track of different implementation choices (shown as shaded blocks in FIG. 8) available for it. For instance, Group 3 represents the join between the two tables. Group 3 has two logical expressions corresponding to the two possible join orderings and an implementation using the hash join (HJ) algorithm. Transformation rules are used to generate different logical alternatives and implementation algorithms for each group. Each plan (sub-plan) is costed by invoking suitable cost functions, and suboptimal plans (sub-plans) are suitably pruned. Once all the rules have been applied, the memo 800 is finally traversed top-down to pick the optimal plan.

In order to extend the optimizer to incorporate authorization indexes, a new logical property (IsAuthorized) is maintained for every group, a new logical rule is added for adding authorization predicates for a table, and a new implementation rule is added for authorization indexes.

Following is a description of the above additions. Since the query optimizer has to now enforce the correctness of an execution plan with respect to the predicated grants (recall that the query rewriter does not exist in this architecture), it is tracked whether each group is authorized or not. This can be tracked by adding the logical property IsAuthorized for a group. Note that a group being authorized is a logical property and does not depend on the specific algorithms used for implementation.

A group in the plan memo (that corresponds to a base table) can be explicitly authorized by adding the authorization predicate (for the appropriate table). This can be implemented by adding a new logical rule to add authorization predicates for a table based on the appropriate predicate grant. The IsAuthorized property can be propagated by using a rule that, a group is authorized if and only if all its children are authorized. Authorization is explicitly enforced by the query optimizer while creating the appropriate groups in the memo, thus bypassing view matching to identify the authorization predicates. While traversing the memo to pick the final plan, the authorized query execution plan with the cheapest cost is selected.

Authorization indexes can be incorporated in such an optimizer by adding the new implementation rule. When an optimizer creates an authorized group for a single table relation by adding the authorization predicate, the implementation rule adds the index seek plan on an authorization index for the table (if it exists) as a possible implementation alternative.

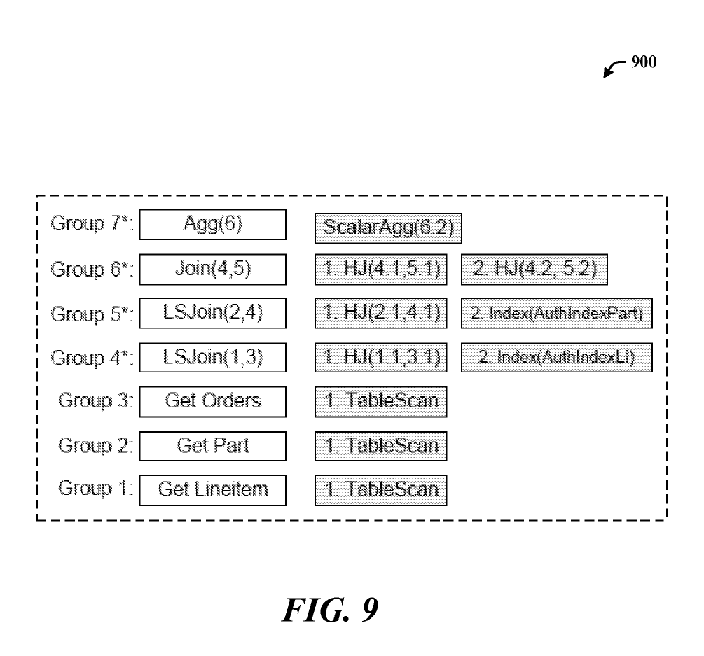

Consider the join query described above. FIG. 9 illustrates a snapshot of a memo 900 for an optimizer modified as described above. The authorized groups (Groups 4-7) are marked with an asterisk “*”. Recall that the authorizations on the lineitem and parts table required additional semi-joins with the orders table in order to restrict the access to a particular customer's information. Notice that the optimizer adds these semi-joins in order to enforce the authorizations in Groups 4 and 5.

The authorization index also serves as an implementation alternative for these groups. For instance, for the Group 5, the implementation alternatives are to use hash joins for enforcing the semi-joins (the HJ(2.1,4.1) alternative) or to use the authorization index. Depending on the cost of the alternatives, either of these plans can be chosen.

Put another way, a system is provided that comprises a mapping component that creates and maintains a mapping (the authorization index) of a user identifier of a user to corresponding record identifiers of a table of a database the user is allowed to access in the table, and a query processing component that employs the mapping in a query rewriter or query optimizer as part of processing a query against the database. The mapping component creates the mapping using a bulk load of items into the mapping based on a predicate that references a predicate table where the predicate is parameterized by a user identifier function, and filters duplicate tuples from a join operation of a predicate table and the table. The query rewriter is a cost-aware rewriter that rewrites the query into rewritings based on consideration of either an authorization predicate or the mapping, the rewritings costed by invoking the query optimizer. The query optimizer receives as input authorization policies and authorization indexes to produce a query execution plan. The query optimizer includes a logical rule that adds authorization predicates to the table based on an appropriate predicate grant and an implementation rule that adds a mapping seek plan onto the mapping for the table.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

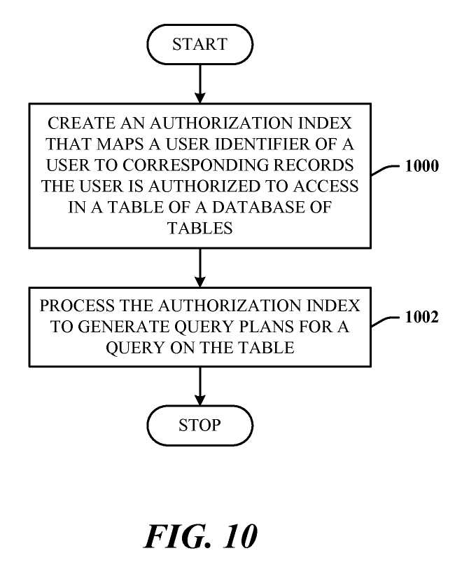

FIG. 10 illustrates a computer-implemented method in accordance with the disclosed architecture. At 1000, an authorization index is created that maps a user identifier of a user to corresponding records the user is authorized to access in a table of a database of tables. At 1002, the authorization index is processed to generate query plans for a query on the table.

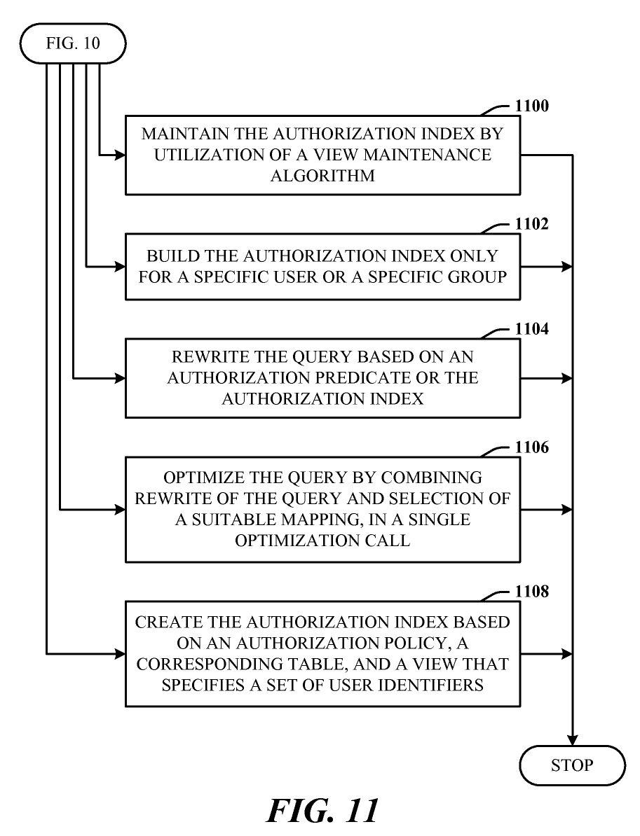

FIG. 11 illustrates further aspects of the method of FIG. 10. Note that the flow indicates that each block can represent a step that can be included, separately or in combination with other blocks, as additional aspects of the method represented by the flow chart of FIG. 10. At 1100, the authorization index is maintained by utilization of a view maintenance algorithm. At 1102, the authorization index is built only for a specific user or a specific group. At 1104, the query is rewritten based on an authorization predicate or the authorization index. At 1106, the query is optimized by combining rewrite of the query and selection of a suitable mapping, in a single optimization call. At 1108, the authorization index is created based on an authorization policy, a corresponding table, and a view that specifies a set of user identifiers.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

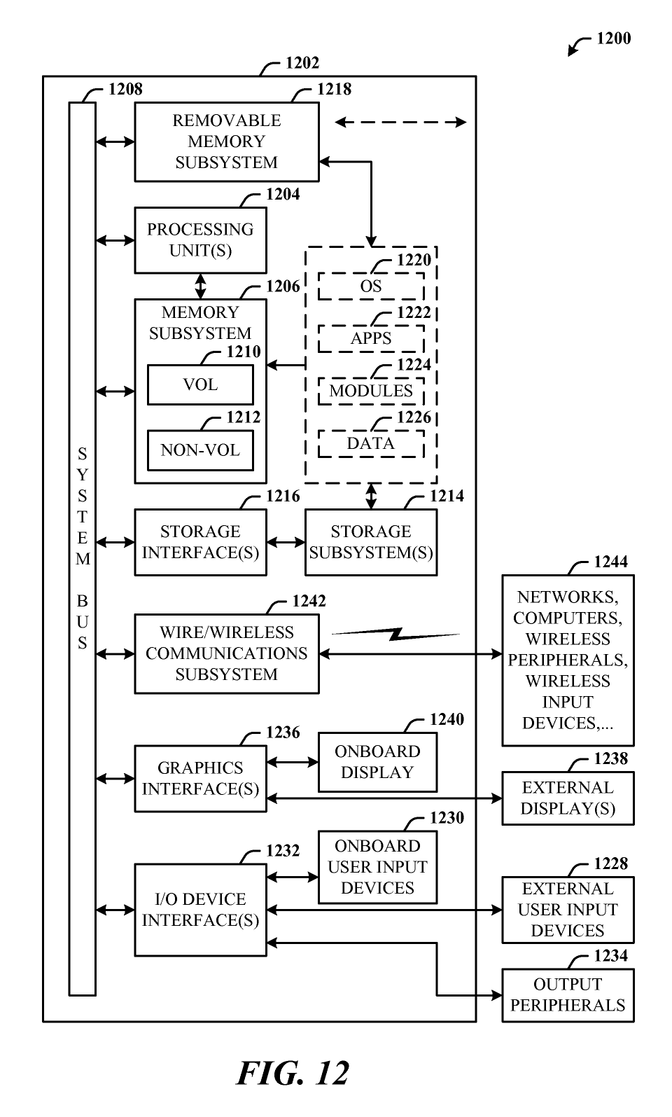

Referring now to FIG. 12, there is illustrated a block diagram of a computing system 1200 that executes fine grained access control in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. In order to provide additional context for various aspects thereof, FIG. 12 and the following description are intended to provide a brief, general description of the suitable computing system 1200 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1200 for implementing various aspects includes the computer 1202 having processing unit(s) 1204, a computer-readable storage such as a system memory 1206, and a system bus 1208. The processing unit(s) 1204 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1206 can include computer-readable storage (physical storage media) such as a volatile (VOL) memory 1210 (e.g., random access memory (RAM)) and non-volatile memory (NON-VOL) 1212 (e.g., ROM, EPROM, EEPROM, etc.). A basic input/output system (BIOS) can be stored in the non-volatile memory 1212, and includes the basic routines that facilitate the communication of data and signals between components within the computer 1202, such as during startup. The volatile memory 1210 can also include a high-speed RAM such as static RAM for caching data.

The system bus 1208 provides an interface for system components including, but not limited to, the system memory 1206 to the processing unit(s) 1204. The system bus 1208 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1202 further includes machine readable storage subsystem(s) 1214 and storage interface(s) 1216 for interfacing the storage subsystem(s) 1214 to the system bus 1208 and other desired computer components. The storage subsystem(s) 1214 (physical storage media) can include one or more of a hard disk drive (HDD), a magnetic floppy disk drive (FDD), and/or optical disk storage drive (e.g., a CD-ROM drive DVD drive), for example. The storage interface(s) 1216 can include interface technologies such as EIDE, ATA, SATA, and IEEE 1394, for example.

One or more programs and data can be stored in the memory subsystem 1206, a machine readable and removable memory subsystem 1218 (e.g., flash drive form factor technology), and/or the storage subsystem(s) 1214 (e.g., optical, magnetic, solid state), including an operating system 1220, one or more application programs 1222, other program modules 1224, and program data 1226.

The operating system 1220, one or more application programs 1222, other program modules 1224, and/or program data 1226 can include entities and components of the system 100 of FIG. 1, plans obtained by utilization of authorization indexes in the example of FIG. 2 and FIG. 3, the exemplary database managements systems of FIG. 4 and FIG. 7, the exemplary algorithms of FIG. 5 and FIG. 6, and the methods represented by the flowcharts of FIGS. 10 and 11, for example.

Generally, programs include routines, methods, data structures, other software components, etc., that perform particular tasks or implement particular abstract data types. All or portions of the operating system 1220, applications 1222, modules 1224, and/or data 1226 can also be cached in memory such as the volatile memory 1210, for example. It is to be appreciated that the disclosed architecture can be implemented with various commercially available operating systems or combinations of operating systems (e.g., as virtual machines).

The storage subsystem(s) 1214 and memory subsystems (1206 and 1218) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 1202 and includes volatile and non-volatile internal and/or external media that is removable or non-removable. For the computer 1202, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 1202, programs, and data using external user input devices 1228 such as a keyboard and a mouse. Other external user input devices 1228 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1202, programs, and data using onboard user input devices 1230 such a touchpad, microphone, keyboard, etc., where the computer 1202 is a portable computer, for example. These and other input devices are connected to the processing unit(s) 1204 through input/output (I/O) device interface(s) 1232 via the system bus 1208, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 1232 also facilitate the use of output peripherals 1234 such as printers, audio devices, camera devices, and so on, such as a sound card and/or onboard audio processing capability.

One or more graphics interface(s) 1236 (also commonly referred to as a graphics processing unit (GPU)) provide graphics and video signals between the computer 1202 and external display(s) 1238 (e.g., LCD, plasma) and/or onboard displays 1240 (e.g., for portable computer). The graphics interface(s) 1236 can also be manufactured as part of the computer system board.

The computer 1202 can operate in a networked environment (e.g., IP-based) using logical connections via a wired/wireless communications subsystem 1242 to one or more networks and/or other computers. The other computers can include workstations, servers, routers, personal computers, microprocessor-based entertainment appliances, peer devices or other common network nodes, and typically include many or all of the elements described relative to the computer 1202. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1202 connects to the network via a wired/wireless communication subsystem 1242 (e.g., a network interface adapter, onboard transceiver subsystem, etc.) to communicate with wired/wireless networks, wired/wireless printers, wired/wireless input devices 1244, and so on. The computer 1202 can include a modem or other means for establishing communications over the network. In a networked environment, programs and data relative to the computer 1202 can be stored in the remote memory/storage device, as is associated with a distributed system. It will be appreciated that the network connections shown are exemplary and other means of establishing a communications link between the computers can be used.

The computer 1202 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system, comprising:
a database component that includes a database having a table and associated table records against which a query is processed;
an authorization index that maintains a mapping of a user identifier of a user to corresponding records the user is allowed to access in the table, the mapping maintained in an appropriate format; and
a processor that executes computer-executable instructions associated with at least one of the database component or the index.

2. The system of claim 1, further comprising a query processing component that employs the mapping in association with a query rewriter.

3. The system of claim 2, wherein the query rewriter is a cost-aware rewriter that rewrites the query based on consideration of either an authorization predicate or the mapping.

4. The system of claim 1, further comprising a query processing component that employs the mapping in association with a query optimizer.

5. The system of claim 4, wherein the query optimizer is an authorization-aware query optimizer that combines rewriting of the query and selection of a suitable mapping, in a single optimization call.

6. The system of claim 1, wherein the mapping is created based on an authorization policy, a corresponding table, and a view that specifies a set of user identifiers.

7. The system of claim 1, wherein the mapping is a partial mapping specific to a role or user-defined group.

8. The system of claim 1, wherein the mapping is maintained according to at least one of base relations on which authorizations are defined, users that have access to the table, or an authorization policy to the table.

9. The system of claim 1, wherein the mapping is incrementally updated based on an incremental maintenance of views using delta propagation rules.

10. A computer-implemented system, comprising:
a mapping component that creates and maintains a mapping of a user identifier of a user to corresponding record identifiers of a table of a database the user is allowed to access in the table;
a query processing component that employs the mapping in a query rewriter or query optimizer as part of processing a query against the database; and
a processor that executes computer-executable instructions associated with at least one of the database component or the mapping component.

11. The system of claim 10, wherein the mapping component creates the mapping using a bulk load of items into the mapping based on an authorization predicate that is parameterized by a user identifier function, and filters duplicate tuples from a join operation of a predicate table and the table.

12. The system of claim 10, wherein the query rewriter is a cost-aware rewriter that rewrites the query into rewritings based on consideration of either an authorization predicate or the mapping, the rewritings costed by invoking the query optimizer.

13. The system of claim 10, wherein the query optimizer receives as input authorization policies and authorization indexes to produce a query execution plan.

14. The system of claim 10, wherein the query optimizer includes a logical rule that adds authorization predicates to the table based on an appropriate predicate grant and an implementation rule that adds a mapping seek plan onto the mapping for the table.

15. A computer-implemented method, comprising acts of:
creating an authorization index that maps a user identifier of a user to corresponding records the user is authorized to access in a table of a database of tables;
processing the authorization index to generate query plans for a query on the table; and
utilizing a processor that executes instructions stored in memory to perform at least one of the acts of creating or processing.

16. The method of claim 15, further comprising maintaining the authorization index by utilization of a view maintenance algorithm.

17. The method of claim 15, further comprising building the authorization index only for a specific user or a specific group.

18. The method of claim 15, further comprising rewriting the query based on an authorization predicate or the authorization index.

19. The method of claim 15, further comprising optimizing the query by combining rewrite of the query and selection of a suitable mapping, in a single optimization call.

20. The method of claim 15, further comprising creating the authorization index based on an authorization policy, a corresponding table, and a view that specifies a set of user identifiers.
